(19) United States
(12) Patent Application Publication
(10) Pub. No.: US 2025/0033036 A1
(43) Pub. Date: Jan. 30, 2025

(54) DEVICE FOR TESTING ANALYTE IN LIQUID SAMPLE

(71) Applicant: Zhejiang Orient Gene Biotech Co.,Ltd, Huzhou (CN)

(72) Inventors: Siyu LEI, Huzhou (CN); Jianqiu FANG, Huzhou (CN)

(21) Appl. No.: 18/659,794

(22) Filed: May 9, 2024

Related U.S. Application Data
(60) Provisional application No. 63/517,459, filed on Aug. 3, 2023.

(30) Foreign Application Priority Data
Jul. 25, 2023 (CN) 2023109190068

(51) Int. Cl. B01L 3/00

(52) U.S. Cl. CPC B01L 3/5023; B01L 2200/0689; B01L 2300/044; B01L 2300/0825

(57) ABSTRACT

The invention provides a device for testing an analyte in a liquid sample, and the device includes: a sample chamber for accommodating a sample collector; a detection chamber with a bottom, where a testing element is provided in the detection chamber and used for testing an analyte in a liquid chamber; and a connecting chamber, where the sample chamber is connected with the detection chamber through the connecting chamber, a liquid is accommodated in the sample chamber, and a level of the liquid in the sample chamber is higher than a bottom of the detection chamber.

### CROSS-REFERENCE TO RELATED APPLICATIONS

This application claims priority to the Chinese Patent Application, Application No. CN2023109190068, filed on Jul. 25, 2023, and to the U.S. Provisional Application, Application No. U.S. 63/517,459, filed on Aug. 3, 2023, and all disclosures of the applications, including but not limited to the specification, abstract, claims and accompanying drawings of this application are hereby made a part of this application.

### BACKGROUND OF THE INVENTION

### Field of the Invention

The invention relates to a device for collecting and testing a liquid sample, and in particular, to a device for testing an analyte in a liquid sample in the field of rapid diagnosis, such as collection of urine and saliva and testing analytes in samples.

### Description of the Related Art

The following description is merely an introduction of some background knowledge and does not constitute any limitation to the invention.

In the field of in vitro diagnosis (IVD), chromatographic techniques are often used to diagnose and detect diseases and other items. For example, immune colloidal gold test strip, dry chemical test strip, immunofluorescence test strip, and the like all react with reagents after samples are pretreated based on the chromatographic theory, so as to finally obtain diagnosis results reflecting whether patients suffer from diseases. The function process of the immunofluorescence test strip is that: after samples (whole blood, plasma, and the like) are dripped into a sample application pad, liquid flows to an absorbent filter paper; the samples are treated in the sample application pad to filtrate erythrocytes and remove interfering substances and the like; when flowing through a conjugate pad, the samples immunobind with antigens and antibodies and carry fluorophores; when flowing through a nitrocellulose membrane, the samples specifically bind with antigens and antibodies bound thereon in advance; and fluorophores gathered on a testing line and a control line can reflect test results, and other interfering substances unbound are absorbed by the absorbent filter paper. Fluorescence immunochromatography has been widely used in the field of POCT detection in recent years because of its simple operation, strong specificity, high sensitivity, and quantification. However, in recent decades, most of immunochromatographic test cards can be used for detection of a single item only in a form of a single card with a single test strip. However, with the development of medical technologies, multiple targets need to be detected at the same time during diagnosis of diseases for more accurate determination, such as myocardial 3-item joint examination and myocardial 5-item joint examination. Under some circumstances, it is necessary to detect the status of multiple organs at the same time to determine the diseases, such as cardiopulmonary 5-item joint examination.

At present, the testing device for detecting the presence or absence of an analyte in sample is widely used in hospitals or homes, and these testing devices for rapid diagnosis include one or more test strips, such as early pregnancy detection and drug abuse detection. Such testing devices for rapid diagnosis are very convenient, and can obtain testing results from the test strips in one minute or at most ten minutes or so. Drug tests are widely used by the drug control department, the Public Security Bureau, drug rehabilitation centers, physical examination centers, physical examination offices of national conscription, etc. Drug tests are diverse and frequent. In some cases, samples need to be collected and then tested by professional testing agencies or test laboratories. and some tests need to be completed in the site in time, for example, roadsides, for example, persons who drive after drug use need to be tested on the spot (referred to as “Drug Driving”), to obtain the testing results in time.

Conventionally, for fecal testing, feces are collected by a collector, and analytes in the samples are tested. Some of the samples are collected and stored by special collection tools, and then sent to professional institutions for testing. Such operation is inconvenient, and during transportation of the samples, the samples will deteriorate and affect the final test and testing results. At present, although there are some integrated fecal collection and testing structures, they always have some disadvantages, such as the control of the sample size collected and the failure of sampling for some special samples. In particular, such structures are very convenient for home self-testing operation. Sometimes, when analytes in feces are tested, it is desired that they can be tested after being collected to obtain the testing results, or test subjects can detect them at home, which requires improving the existing conventional sample collection and detection.

### BRIEF SUMMARY OF THE INVENTION

In order to overcome the defects of the prior art, the invention provides a device for testing an analyte in a liquid sample, and the device includes: a sample chamber for accommodating a sample collector; a detection chamber, where a testing element that can test the analyte in the liquid sample is provided in the detection chamber; and the device further includes a chamber, where the chamber is connected with the sample chamber and the detection chamber.

In some embodiments, the connecting chamber is in fluid communication with the sample chamber, instead of the detection chamber; therefore, gas or liquid in the connecting chamber cannot flow into the detection chamber, and liquid or gas in the sample chamber is in an integral space with the connecting chamber.

In some embodiments, the device further includes a channel, and the channel is connected with the connecting chamber and the detection chamber, such that the detection chamber can be in fluid communication with the channel.

In some embodiments, the connecting chamber is located in a base, and both the sample chamber and the detection chamber are located on the base. In some embodiments, the base is provided with the channel, one end of the channel is connected with the base, and the other end of the channel is connected with the detection chamber. In some embodiments, a sealing film is provided in the channel, and the sealing film causes the connecting chamber on the base or a base chamber to be isolated from the detection chamber, such that the detection chamber is not in communication with the base chamber. In some embodiments, when the sealing film is removed or pierced, the detection chamber is in fluid communication with the base chamber. In some embodiments, a liquid for treating a sample is accommodated in the sample chamber and the base chamber; and the liquid is used for dissolving the sample and contains no analyte.

In some embodiments, the device further includes a piercing element; the piercing element can pierce the sealing film. Of course, in an initial state, the piercing element does not pierce the sealing film, such that the detection chamber is isolated from the sample chamber and the base chamber; and when a treatment liquid is stored in the sample chamber, the testing element of the detection chamber is isolated and will not fail due to humidity. When testing needs to be performed, the piercing element is allowed to pierce the sealing film, such that the detection chamber is in fluid communication with the base chamber, and liquid in the base chamber can flow to the detection chamber for testing and assay.

In some embodiments, the testing element of the detection chamber is located above the base chamber, and how to make the liquid flow back to the detection chamber from a lower position is a technical problem of the invention. A basic idea is to make pressure applied to the liquid in the base chamber, such that the liquid can flow into the detection chamber. Therefore, in some embodiments, one channel is provided; the base chamber and the detection chamber are connected by the channel, and the sealing film is provided in the channel and can be in a pierced or non-pierced state, such that the base chamber and the detection chamber are located at a communicating or non-communicating position. In some embodiments, a piston is provided in the channel, and the piston can move in the channel. The movement of the piston leads to an increase in the pressure in the channel, for example, pressure for rising compressed air or pressure applied to liquid. The applied pressure is finally applied to the liquid, and the liquid flows into the detection chamber and contacts the testing element of the detection chamber due to the pressure. Therefore, as long as a pressure difference is formed between the detection chamber and the base chamber, and generally, the pressure in the detection chamber is less than that in the base chamber, the pressure difference can cause the liquid in the base chamber to reversely overcome gravity and flow into the detection chamber located on the base chamber. In some embodiments, the sealing film is used for sealing one end close to the base chamber, the piston is located above the sealing film, and there is a section of air between the sealing film and the piston. When the piston is located at the initial position, the air is not compressed; and when the piston approaches the sealing film in the channel, the air is compressed, which increases the pressure. When the piston continues to move downward and if the sealing film is pierced, the increased pressure is applied to the liquid and the liquid increases; in order to balance the increased pressure with the outside, the excess liquid flows backwards to a high part of the channel and contacts with the testing element located at the high part. Therefore, in some embodiments, the piston is also a chamber structure or a pipe structure; and a piston pipe moves in the channel and the piercing element is located on the piston pipe. In some embodiments, one end of the piston pipe is provided with a sharp or razor-sharp structure on an edge thereof, while the other end thereof is connected to the detection chamber, and when the detection chamber moves, the piston pipe and the piercing element are driven to synchronously move together.

In some embodiments, the piston pipe is in fluid communication with the detection chamber. In some embodiments, the detection chamber and the piston pipe are in communication with the outside atmosphere, and the sample chamber is sealed by the sample collector. The sample collector is sealed, indicating that the sample collector can seal the sample chamber and apply pressure to the air in the sample chamber. Such pressure can cause the liquid in the sample chamber to flow into the base chamber and then flow into the detection chamber through the base chamber.

When there is not much treatment liquid in the sample chamber, the treatment liquid is allowed to flow into the detection chamber under the pressure. When there is sufficient treatment liquid in the sample chamber, the treatment liquid can flow into the detection chamber in absence of the pressure.

Therefore, in some embodiments, the invention provides a testing device, and the testing device includes a sample chamber and a detection chamber; a barrier film or a sealing film is provided between the sample chamber and the detection chamber to block fluid communication between the sample chamber and the detection chamber; and a liquid for treating a sample is accommodated in the sample chamber, and a level of the liquid in the sample chamber is higher than a bottom of the detection chamber. In the initial position, because a partition or a barrier is provided between the two chambers, the treatment liquid in the sample chamber will not flow into the detection chamber; when testing needs to be performed, the partition is removed or the sealing film is pierced, and the two chambers are allowed to be in fluid communication; the liquid in the sample chamber at a high liquid level will flow into the detection chamber at the low level until the levels of the liquids in the two chambers are substantially the same, and the liquid will no longer flow; if the treatment liquid is accommodated in the detection chamber, an analyte in the treatment liquid can be tested. In some embodiments, the treatment liquid in the sample chamber can be replaced by the liquid sample, so if there is the liquid sample in the sample chamber, the liquid sample can directly flow to the detection chamber to test the analyte. In some embodiments, when the treatment liquid is accommodated in the sample chamber, the sample chamber is used for accommodating the sample collector, and the collector is used for collecting the sample; therefore, when the sample collector is inserted into the sample chamber, the treatment liquid is used for treating the sample on the sample collector to form a mixed liquid. Therefore, in the invention, regardless of the liquid sample or the treatment liquid, or a mixture of the treatment liquid and the sample, all these may fall into the definition of the liquid.

In some embodiments, one base is provided between the detection chamber and the sample chamber that are located on the base, and the base includes one base cavity, so the detection chamber and the sample chamber are connected through the base chamber, one partition is provided in the base chamber, and the partition being located at the initial position can prevent the liquid in the sample chamber from flowing into the detection chamber; when testing needs to be performed, the partition is removed, the detection chamber is allowed to be in fluid communication with the sample chamber, the liquid in the sample chamber at a high level flows into the detection chamber through the base chamber, and the liquid contacts with the testing element of the detection chamber for testing. In some embodiments, one channel is provided in the base; the channel is in communication with the base chamber and the detection chamber. When the base chamber and the sample chamber are in fluid communication, the base chamber is also filled with the liquid. Therefore, the barrier is provided on the channel, for example, the channel is plugged with a sealing plug, or one end of the channel is sealed by the sealing film, such that the base chamber is not in communication with the detection chamber and the channel is located in the base chamber.

When testing is not initially performed, the sealing film is provided on the channel to block fluid communication between the two chambers. When testing needs to be performed, the sealing film is pierced, the liquid at the high level will automatically flow into the detection chamber at a bottom level. When the liquid levels of the detection chamber and the sample chamber are kept equal, testing can be performed.

In some embodiments, the detection chamber has a first position and a second position. When the detection chamber is located at the first position, the detection chamber is located in an initial state, instead of being tested. When the detection chamber is located at the second position, the liquid is accommodated in the detection chamber and the analyte can be tested and analyzed. In some embodiments, the piercing element is provided on the detection chamber; when the detection chamber is located at the first position, the piercing element is far away from the sealing film; when the detection chamber is located at the second position, the sealing film is pierced by the piercing element, such that the base chamber is in fluid communication with the detection chamber, and the sample chamber is in fluid communication with the base chamber and the detection chamber. Thus, the base chamber is in fluid communication with the sample chamber at first.

In some embodiments, the base chamber is in communication with the sample chamber at first, and there is also one sealing film between the sample chamber and the base chamber. In this case, there is no liquid in the base chamber, but liquid only in the sample chamber. When testing is performed, the sample collector is inserted into the sample chamber and the sealing film is pierced. In this case, the liquid will flow into the base chamber, and the detection chamber will be moved from the first position to the second position, thereby piercing the sealing film and allowing the liquid in the base chamber to flow into the detection chamber. When the liquid in the sample chamber has a same level as that in the detection chamber, the liquid stops flowing.

In some embodiments, the detection chamber includes a vent hole in communication with the outside atmosphere, to ensure that the liquid smoothly flows into the detection chamber without additional pressure. In some embodiments, the sample chamber also includes a liquid-impermeable hole that is in communication with the outside atmosphere; therefore, in design, the detection chamber and the sample chamber are similar to a communicating vessel, thereby ensuring the liquid in the sample chamber at the high level flows into the detection chamber. In one embodiment, the sample application area of the testing element is close to the bottom of the detection chamber.

In some embodiments, the detection chamber moves downward (longitudinally) from the first position, such that the bottom of the detection chamber has a great drop height with the sample chamber, which is convenient for the liquid to flow into the detection chamber quickly. In some embodiments, when the detection chamber is located at the first position, one limiting structure needs to be provided, such that the detection chamber is kept at an immovable position. When the limiting structure is removed, the detection chamber can move from the first position to the second position. In some embodiments, the sample chamber further has a chute along which the detection chamber moves from top to bottom. In some embodiments, the testing device includes the piercing element; and when the testing device moves from the first position to the second position, the piercing element pierces the sealing film. In some embodiments, the test chamber includes one pushing rod, and one sealing plug is provided in the channel; when the detection chamber moves from the first position to the second position, the pushing rod pushes the sealing plug out of the channel, such that the base chamber is in communication with the detection chamber communicate through the channel, and the liquid can flow into the bottom of the detection chamber through the channel until the liquid in the sample chamber has a same level as that in the detection chamber.

In addition, the invention provides a method for testing an analyte in a liquid sample, and the method includes: providing a testing device, where the device includes a sample chamber in which a liquid is accommodated; a detection chamber, where the detection chamber includes a testing element for testing the analyte in the liquid sample, a barrier for blocking fluid communication between the detection chamber and the sample chamber is provided between the two chambers, the level of the liquid in the sample chamber is higher than the bottom of the detection chamber, and the barrier is removed, such that the detection chamber is in fluid communication with the sample chamber, and the liquid in the sample chamber flows from the high level of the liquid in the sample chamber to the detection chamber at the low level by virtue of gravity.

In some embodiments, the barrier is an easy-to-pierce sealing film, and one channel is provided between the detection chamber and the sample chamber. The sealing film is used for sealing one end of the channel. When located at the initial position, the fluid communication between the detection chamber and the sample chamber is blocked by the sealing film; when testing needs to be performed, the detection chamber is moved to pierce the sealing film, such that the detection chamber is in fluid communication with the sample chamber, and the liquid in the sample chamber flows from the high level of the liquid in the sample chamber to the detection chamber at the low level by virtue of gravity.

In some embodiments, the barrier is the sealing plug, and one channel is provided between the detection chamber and the sample chamber. The sealing plug is located in the channel. When located at an initial position, the fluid communication between the detection chamber and the sample chamber is blocked by the sealing plug; when testing needs to be performed, the detection chamber is moved to detach the sealing plug from the channel, such that the detection chamber is in fluid communication with the sample chamber, and the liquid in the sample chamber flows from the high level of the liquid in the sample chamber to the detection chamber at the low level by virtue of gravity

In some embodiments, the device further includes one base in which a base chamber is provided, and the detection chamber is in fluid communication with the sample chamber through the base chamber; the sealing film is provided between the base chamber and the detection chamber or between the base chamber and the sample chamber, such that the sealing film can be used for partitioning the base chamber from the detection chamber without fluid communication; or the sealing film can be used for partitioning the base chamber from the detection chamber without fluid communication. Thus, the level of the liquid in the sample chamber is higher than a lowest surface of the detection chamber, and in this case, the flow of the liquid is not made between the sample chamber and the detection chamber due to the sealing of the sealing film. When testing needs to be performed, the sample collector can be inserted into the sample chamber; when the sample is allowed to contact with the liquid in the sample chamber, the sample collector pierces the sealing film between the sample chamber and the base chamber, the liquid in the sample chamber is allowed to flow into the base chamber, the detection chamber is moved from the first position to the second position to pierce the sealing film between the detection chamber and the base chamber, and the liquid in the base chamber is allowed to flow into the detection chamber, provided that the liquid in the sample chamber still has a higher level than the bottom of the detection chamber after flowing into the base chamber.

### Beneficial Effect

The invention realizes detection through the movement of the detection chamber, and step-by-step detection can be performed to choose an appropriate time, which overcomes that the existing conventional device realizes the detection during the collection. The step-by-step detection is particularly suitable for the elderly, and the general elderly can collect liquid samples on their own, but are not skillful in detection operation. However, they can allow their own family members to perform such operation or send the collected samples to the infirmary to perform such operation, thereby reducing operation errors.

### BRIEF DESCRIPTION OF THE DRAWINGS

FIG. 1 is a structural schematic diagram of a testing element according to a specific embodiment of the invention.

FIG. 2 is a schematic diagram showing a three-dimensional structure of a testing element according to a specific embodiment of the invention.

FIG. 3 is an exploded view of a decomposition structure of a testing device according to the invention.

FIG. 4 is a schematic diagram showing a three-dimensional structure of a testing device according to the invention.

FIG. 5 is a schematic diagram showing a three-dimensional structure of a testing device (an upper cover plate of a detection chamber is removed).

FIG. 6 is a pattern block diagram (a base is removed) of a testing device according to the invention.

FIG. 7 is a schematic diagram showing a longitudinal cross-sectional structure of a sample chamber.

FIG. 8 is a schematic diagram of a three-dimensional structure of a sample chamber.

FIG. 9 is a schematic diagram showing a three-dimensional structure of a detection chamber.

FIG. 10 is a schematic diagram of a three-dimensional structure of an assembled testing device, where a collector is inserted into a sample chamber and pierces a sealing film between a base chamber and a sample chamber.

FIG. 11 is an exploded view of a decomposition structure of a testing device according to another embodiment of the invention.

FIG. 12 is a schematic diagram showing an assembled three-dimensional structure of a testing device according to another embodiment of the invention.

FIG. 13 is a schematic diagram showing a cross-sectional structure of a testing device according to another embodiment of the invention.

### DETAILED DESCRIPTION OF THE INVENTION

The structures involved in the invention or the technical terms used are further explained below. Unless otherwise specified, they shall be understood and explained according to the general terms commonly used in the art.

### Detection

Detection means to assay or detect presence or absence of a substance or material, including but not limited to, a chemical substance, an organic compound, an inorganic compound, a metabolite, a drug, a drug metabolite, an organic tissue, a metabolite of an organic tissue, a nucleic acid, a protein or a polymer. In addition, detection means that the amount of a substance or material is tested. Further, assay also means immunoassay, chemical assay, enzyme assay, and the like.

### Samples

Samples tested by the testing device of the invention include biological fluid (for example, case fluid or clinical sample). Liquid samples or liquid specimens may be derived from solid or semi-solid samples, including feces, biological tissues and food samples. The solid or semi-solid specimens may be converted to liquid specimens by any appropriate methods, such as mixing, mashing, macerating, incubating, dissolving, or digesting the solid specimens by enzymolysis in suitable solutions, such as water, phosphate solutions, or other buffer solutions. “Biological samples” include animal, plant, and food derived samples, including, for example, human or animal derived urine, saliva, blood and components thereof, spinal fluid, vaginal secretions, sperm, feces, sweat, secretions, tissues, organs, tumors, cultures of tissues and organs, cell cultures, and media. Preferably, the biological specimen is urine; and preferably, the biological specimen is saliva. Food samples include food processing substances, final products, meat, cheese, wine, milk, and drinking water. Plant specimens include specimens derived from any plants, plant tissues, plant cell cultures, and media. “Environmental specimens” include specimens derived from the environment (for example, liquid specimens from lakes or other bodies of water, sewage specimens, soil specimens, groundwater, seawater, and waste liquid specimens). The environmental specimens may further include sewage or other waste water.

An appropriate testing device according to the invention can be used for testing any analyte. Preferably, the testing device of the invention is used for testing small drug molecules in saliva and urine. Of course, the samples detected by the testing device of the invention may be any samples of the above forms, regardless of being solid or liquid at the beginning, provided that these liquids or liquid samples can be absorbed by the sample application area of the testing element. Generally, the sample application area is made of a water absorbent material, and liquid samples or liquid specimens can be absorbed by the capillary or other characteristics of the material of an absorption element, such that the liquid sample can flow in the sample application area. The material of the liquid sample application area may be any material capable of absorbing liquid, such as sponge, filter paper, polyester fiber, gel, non-woven fabric, cotton, polyester film, and yarn. Of course, the liquid sample application area may be made of a water absorbent material or a non-water absorbent material. However, the absorption element is provided with holes, screw threads, and caves on which the samples can be collected. Generally, the samples are solid or semi-solid samples, and filled between screw threads and in the holes or caves for collection. Of course, optionally, the sample application area may be composed of some non-absorbent fibers and hairs, and these materials are used for scraping a solid, semi-solid or liquid sample, such that these samples can be retained on the sample application area. If detection is needed, a buffer solution is applied to the sample application area to dissolve the sample, such that the dissolved sample flows on the testing element or the detection element.

In some embodiments, the sample of the invention is a fecal sample, and the collecting rod of the collector is provided with a screw thread, which enables the fecal sample to be positioned in the screw thread.

### Liquid

The term “liquid” as used herein can have different meanings in different contexts. The liquid may include a liquid sample in the form of a liquid, or may include a treatment liquid for treating a liquid sample, for example, a solid sample is allowed to be dissolved in the treatment liquid, or the liquid sample is allowed to be dissolved in the treatment liquid, thereby forming a mixed solution formed by the treatment liquid and the liquid sample, or the treatment liquid and the solid sample. When the liquid is used as the treatment liquid, generally the solution herein is water as a solvent, and the treatment liquid may include other reagents to improve the test performance, for example, a PH regulation reagent, some reagents to remove impurities from the samples, or a reagent to dissolve the samples, but does not include a target analyte. Therefore, generally, the treatment liquid is accommodated in the sample chamber 105, and the sample collected by the sample collector 104 may be the liquid sample, the solid sample, or a semi-solid sample between a solid and a liquid. When the sample collector is inserted into the sample chamber, the sample on the sample collector contacts with the treatment liquid in the sample chamber, such that the sample can be dissolved in the treatment liquid, especially, if the sample contains the target analyte, the target analyte can be dissolved in the treatment liquid. Of course, if the liquid itself is in the form of the liquid sample, the treatment liquid may or may not be accommodated in the sample chamber in advance. When the liquid sample is urine, the urine directly flows into the sample chamber. When the liquid sample is in the form of saliva, nasal mucus, sputum and other liquids, the treatment liquid can be stored in the sample chamber in advance to treat these liquid samples.

### Downstream and Upstream

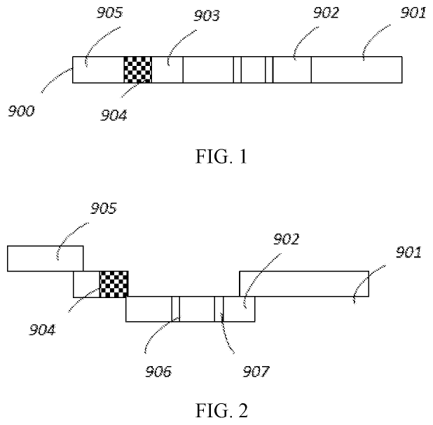

Downstream or upstream is divided according to a flow direction of a liquid, generally, a liquid or fluid flows to a downstream area from an upstream area. The downstream area receives the liquid from the upstream area, and a liquid also may flow to a downstream area along an upstream area. Here, downstream or upstream is generally divided according to a flow direction of a liquid, for example, on some materials where capillary force is utilized to facilitate the flow of a liquid, a liquid may overcome gravity to flow towards an opposite direction to the gravity; and in this case, downstream or upstream is divided according to a flow direction of the liquid. For example, in the testing device of the invention, after a diversion element receives the liquid sample, fluid can flow from the diversion element to a sample application area or a sample application pad of two testing elements, and then liquid flowing to the sample application pad flows to a downstream label pad and is mixed with the marked label; and the mixture flows to a downstream testing pad through a transition pad, where a testing area on the testing pad is located upstream of a testing result control area, such that the mixture finally flows to an absorption pad on a downstream absorption area. The testing area may be a polyester fiber film, and the diversion element may be a glass fiber, a polyester chip, and a polyester film. In this case, the diversion element is located at the upstream of the label area of the testing element. The specific structure of the testing element is a structure 90 as shown in FIG. 1 and FIG. 2. Liquid on a part of the sample application pad flows mainly by a capillary force.

### Gas Communication or Liquid Communication

Gas communication or liquid communication means that liquid or gas can flow from one place to another. In the flow process, the liquid or gas may pass through some physical structures that play a guiding role. The “passing through some physical structures” here means that liquid passes through the surface of these physical structures or their internal space and flows to another place passively or actively, where passivity is usually caused by external forces, such as flow under the capillary action and the action of air pressure. The flow here may also be a flow due to self-action (gravity or pressure) of the liquid or gas, and also may be a passive flow. The fluid under the action of air pressure may be a forward flow, or also a reverse flow; or a fluid is urged to flow to another position from a position under the action of air pressure. The communication here does not mean that a liquid or a gas is necessarily present, but indicates a relationship or state between two objects under some circumstances. If a liquid is present, it can flow from one object to another. Here it means the state in which two objects are connected. In contrast, if there is no liquid or gas communication state between two objects, and a liquid exists in or on one object but is unable to flow into or on another object, it is a non-communication, non-liquid communication or non-gas communication state.

### Testing Element

The “testing element” used herein refers to an element that can be used for testing whether a fluid sample or a fluid specimen (a liquid sample or a liquid specimen) contains an interested analyte. Such testing can be based on any technical principles, such as immunology, chemistry, electricity, optics, molecular science, nucleic acids, and physics. The testing element can be a lateral flow test strip that can detect a variety of analytes. Of course, other suitable testing elements can also be used in the invention. In the invention, the testing element and the “lateral flow testing element, or test strip” can be used interchangeably, indicating same meanings.

Various testing elements can be combined for use in the invention. One form of the testing elements is a test strip. The test strips used for analyzing the analyte (such as drugs or metabolites that show physical conditions) in samples can be of various forms such as immunoassay or chemical analysis. The test strips may adopt a non-competitive or competitive analysis mode. A test strip generally contains a water absorbent material that has a sample application area, a reagent area, and a testing area. Fluid or liquid samples are added to the sample application area and flow to the reagent area under the capillary action. If analyte exists in the reagent area, samples will bind to the reagent. Then, the samples continue to flow to the testing area. Other reagents such as molecules that specifically bind to the analyte are immobilized in the testing area. These reagents react with the analyte (if any) in the sample and bind to the analyte in this area, or bind to a reagent in the reagent area. The label used to display the detection signal exists in the reagent area or the detached label area.

In a typical non-competitive analysis mode, if a sample contains the analyte, a signal will be generated; and if not, no signal will be generated. In a competitive method, if no analyte exists in the sample, a signal will be generated; and if the analyte exists, no signal will be generated.

The testing element may be a test strip, which may be made of a water absorbent material or non-water absorbent material. The test strip may contain several materials used for delivery of liquid samples. One material of the test strip can cover the other material thereof. For example, the filter paper covers the nitrocellulose membrane. One or more materials may be used in one area of the test strip, and one or more other different materials may be used in the other area. The test strip can be stuck to a certain support or on a hard surface for improving the strength of holding the test strip.

The analyte is detected through a signal generating system. For example, one or more enzymes that specifically react with this analyte is or are used, and the above method of fixing a specific binding substance on the test strip is used for fixing the combination of one or more signal generating systems in the analyte testing area of the test strip. The substance that generates a signal may be in the sample application area, the reagent area or the testing area, or on the entire test strip, and one or more materials of the test strip may be filled with this substance. The solution containing a signifier is added onto the surface of the test strip, or one or more materials of the test strip is or are immersed in a signifier-containing solution. The test strip containing the signifier solution is dried.

Various areas of the test paper or the lateral flow test strip 900 of the invention can be disposed as follows: sample application area 905, label area 904, and testing area 902, where the testing area includes a testing result area 906 and a testing result control area 907. The control area is located behind or downstream of the testing area. All areas can be disposed on a test strip that is only made of one material. Alternatively, different areas may be made of different materials. Each area can be in direct contact with the liquid sample, or different areas are arranged according to the flow direction of liquid sample; and a tail end of each area is connected and overlapped with the front end of another area. Materials used can be those with good water absorption such as filter paper, glass fibers or nitrocellulose membranes. The test strip may also be in other forms.

The nitrocellulose membrane test strip is commonly used, that is, the testing area includes a nitrocellulose membrane (NC) on which a specific binding molecule is immobilized to display the testing result; and other test strips such as cellulose acetate membrane or nylon membrane test strips can also be used. For example, test strips and similar devices with test strips disclosed in the following patents: U.S. Pat. Nos. 4,857,453; 5,073,484; 5,119,831; 5,185,127; 5,275,785; 5,416,000; 5,504,013; 5,602,040; 5,622,871; 5,654,162; 5,656,503; 5,686,315; 5,766,961; 5,770,460; 5,916,815; 5,976,895; 6,248,598; 6,140,136; 6,187,269; 6,187,598; 6,228,660; 6,235,241; 6,306,642; 6,352,862; 6,372,515; 6,379,620, and 6,403,383. The test strips and similar device with test strips disclosed in the above patents may be applied to the testing element or testing device of the invention for the test of an analyte, for example, the test of an analyte in a sample.

Test strips used in the invention may be commonly referred as lateral flow test strips. The specific structure and detection principle of the test strips are well known to a person skilled in the art in the prior art. A common test strip 900 (as shown in FIG. 1-FIG. 2) includes a sample collection area or a sample application area 905, a label area 904, and a testing area 902; the sample collection area includes a sample receiving pad or a sample application pad; and the label area includes a label pad. The test strip may further include a water absorption area 901 to absorb the liquid sample from the nitrocellulose membrane and the water absorption area may include a water absorption pad. In some embodiments, the label area includes color particles conjugated with antibodies, and the color particles may be latex particles, gold particles, or dyes. The testing area 902 includes necessary chemical substances, such as immunoreagents or enzyme chemical reagents, all which can detect presence or absence of an analyte. The nitrocellulose membrane test strip is commonly used, that is, the testing area 902 includes a nitrocellulose membrane, and an area 906 (T-line) on which a specific binding molecule is immobilized to display the testing result; and other test strips such as cellulose acetate membrane or nylon membrane test strips can also be used. Of course, in the downstream of the testing area, there may also be a testing result control area 907 (C-line); generally, test strips appear on the testing result control area and the testing area in the form of a horizontal line, namely, a test line or a control line. Such test strips are conventional. Of course, they can also be other types of test strips for detection under the capillary action. In addition, there are dry chemical reagent components on common test strips, for example, an immobilized antibody or other reagents. When the test strip contacts a liquid, the liquid flows along the test strip under the capillary action, and the dry reagent components are dissolved in the liquid and treated in a next area, and the dry reagents react in the area for necessary detection. The liquid flow mainly relies on the capillary action. Here, all of the test strips can be applied to the testing device of the invention or can be disposed in contact with the liquid samples in a detection chamber or used for testing the presence or absence of an analyte in the liquid samples that enter a detection chamber, or the quantity thereof.

In addition to the foregoing test strip or lateral flow test strip which is used to contact with the liquid sample to test whether the liquid samples contain analytes. The testing element of the invention may be used as a testing device by itself to detect an analyte in a sample. Therefore, the testing device here is equal to a testing element. For example, after mixed with a treatment liquid, the liquid sample is detected with a testing element directly, specifically described as follows: When a receiving device is described to treat a liquid sample, the testing element may be used for detection alone.

### Analyte

Examples that can use an analyte related to the invention include some small-molecule substances, including drugs (such as drug of abuse). “Drug of Abuse” (DOA) refers to the use of a drug (typically functions to paralyze the nerves) not directed to a medical purpose. Abuse of these drugs will lead to physical and mental damage, dependency, addiction and/or death. Examples of drug abuse include cocaine; amphetamine (AMP) (e.g., Black Beauty, white amphetamine tablets, dexamphetamine, dexamphetamine tablets, and Beans); methamphetamine (MET) (crank, meth, crystal and speed); barbiturate (BAR) (such as Valium, Roche Pharmaceuticals, Nutley, and New Jersey); sedatives (i.e., a sleep aid medicine); lysergic acid diethylamine (LSD); inhibitors (downers, goofballs, barbs, blue devils, yellow jackets, and methaqualone); tricyclic antidepressants (TCAs, i.e. imipramine, amitriptyline, and doxepin); dimethylenedioxymethylaniline (MDMA); phencyclidine (PCP); tetrahydrocannabinol (THC, pot, dope, hash, weed, etc.); opiates (i.e., morphine (MOP) or opium, cocaine (COC), heroin, and hydroxydihydrocodeinone); and anxiolytic drugs and sedative-hypnotic drugs. The anxiolytic drugs are mainly used for relieving anxiety, tension, and fear, and stabilizing emotion, and have hypnotic and sedative effects. The anxiolytic drugs include benzodiazepines (BZO), atypical benzodiazepines (BZ), fused dinitrogen NB23C, benzodiazepines, ligands of BZ receptors, open-ring BZ, diphenylmethane derivatives, piperazine carboxylates, piperidine carboxylates, quinazolinones, thiazine and thiazole derivatives, other heterocycles, imidazole-type sedative/analgesic drugs (e.g., oxycodone (OXY) and methadone (MTD)), propylene glycol derivatives-carbamates, aliphatic compounds, anthracene derivatives, and the like. The testing device of the invention may also be used for detecting drugs belonging to a medical use but easy to be taken excessively, such as tricyclic antidepressants (imipramine or analogues) and acetaminophen. These drugs are metabolized into micromolecular substances after absorbed by human body. These micromolecular substances exist in blood, urine, saliva, sweat and other body fluids or in some body fluids.

For example, the analyte detected by the invention includes but is not limited to creatinine, bilirubin, nitrite, (nonspecific) proteins, hormones (for example, human chorionic gonadotropin, progesterone, follicle-stimulating hormone, etc.), blood, leucocytes, sugar, heavy metals or toxins, bacterial substances (such as proteins or carbohydrates against specific bacteria, for example, Escherichia coli 0157: H7, Staphylococcus, Salmonella, Fusiformis, Campylobacter genus, L. monocytogenes, Vibrio, or Bacillus cereus) and substances related with physiological features in a urine sample, such as pH and specific gravity. Chemical analysis of any other clinical urine may be performed by lateral flow test in combination with the device of the invention. Such chemical analysis can be also used for testing the presence of virus antigens, such as COVID-19 antigen and influenza antigen.

### Carrier Including Testing Element

In some specific embodiments, the testing element may be also disposed on some carrier elements; and the carrier elements include the testing element to complete the detection and assay of the analytes in liquid samples. Therefore, in some embodiments, the testing device includes a carrier, and the carrier is provided with a testing element. In some embodiments, the carrier of the invention is a housing used for bearing or accommodating the testing element; the carrier element does not participate in the detection directly by itself, but serves as a carrier or housing used for bearing or accommodating the testing element. For example, as shown in FIG. 1, a carrier 103 is provided, where grooves 1032 are provided in the carrier and are configured to accommodate the testing element 900. One of the carriers can be provided with a plurality of grooves, and each of the grooves is provided with one testing element. Generally, the sample application area of the testing element is located at or extends from one end 1034 of the groove having an opening. After the testing element is provided in the groove, a transparent film covers the surface of the carrier 103, and then the carrier 103 is inserted into a detection chamber 102. The detection chamber has two faces opposite a plane. The carrier 103 is inserted into the detection chamber 102 and rests on the surface of the plane, while the face having the testing element rests on the plane, such that testing results on the testing element can be read through a transparent surface of the detection chamber during the test.

In some embodiments, each of the grooves in the carrier 301 has a protruding structure at one end thereof, and the protruding structure allows the testing element to be fixed in the groove. Generally, the convex structure is the position of the water absorption pad stuck on the water absorption area of the testing element.

### Detection Chamber Including Testing Element

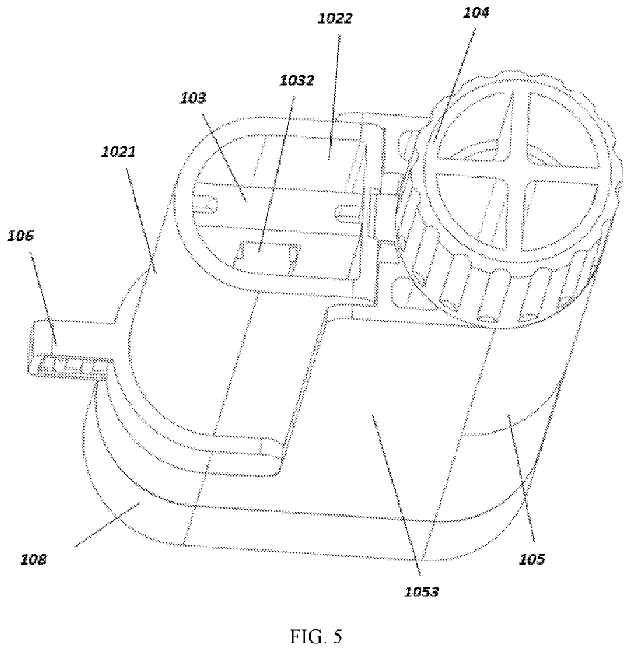

In some specific embodiments, the invention provides a detection chamber 102, and the detection chamber includes a testing element, and the testing element may be provided in one or in plurality. In some embodiments, the testing element is provided on a carrier, and the carrier 103 includes a plurality of grooves, each of the grooves is provided with a test strip, and the carrier is located in the detection chamber. As shown in FIG. 1 and FIG. 5, the detection chamber includes an opening 1022; and when the carrier is inserted into the opening, the opening is sealed by one end of the carrier. Alternatively, the carrier is directly inserted into the detection chamber, and the opening 1022 of the detection chamber is sealed by a cover plate 101. The detection chamber is enclosed by a bottom 1028 of the detection chamber and side walls; and an outwardly extending channel 1024 is provided in the bottom 1028 of the detection chamber and defined by an extending pipe body; the channel 1024 is in fluid communication with the detection chamber 102; and the liquid is allowed to flow into the bottom of the detection chamber 102 through the channel 1024. In some embodiments, the channel 1024 has an outlet, structures 1027 in the form of sharp blades are provided at the channel edge of the outlet, and these sharp structures are used for piercing the sealing film 107. In some embodiments, the detection chamber includes a flat surface 1026, two opposite vertically flat surfaces 1023, 1029 around the surface, and a curved surface 1021; and the side walls of the detection chamber are enclosed by these surfaces. The detection chamber has the opening 1022 and the bottom 1028. When the carrier 103 with the test strip 900 is inserted into the detection chamber, the sample application area 905 of the testing element 900 faces downward and is close to the bottom 1028.

### Sample Chamber and Detection Chamber

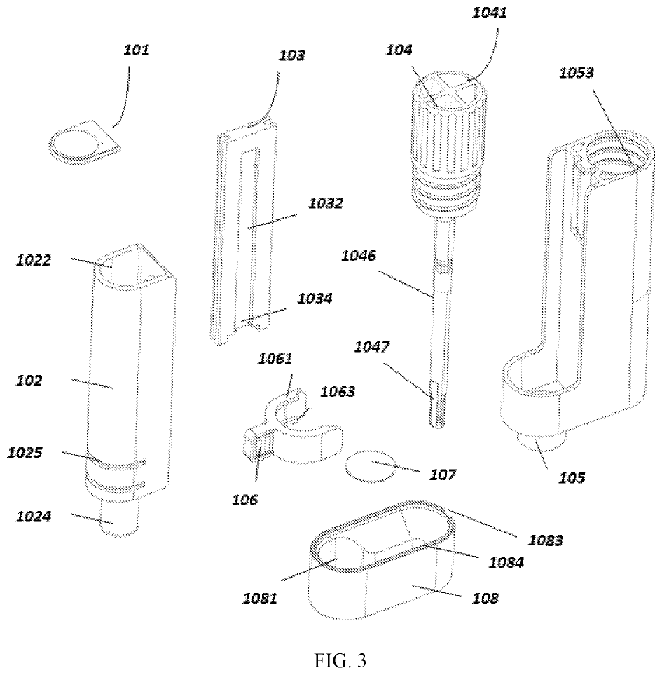

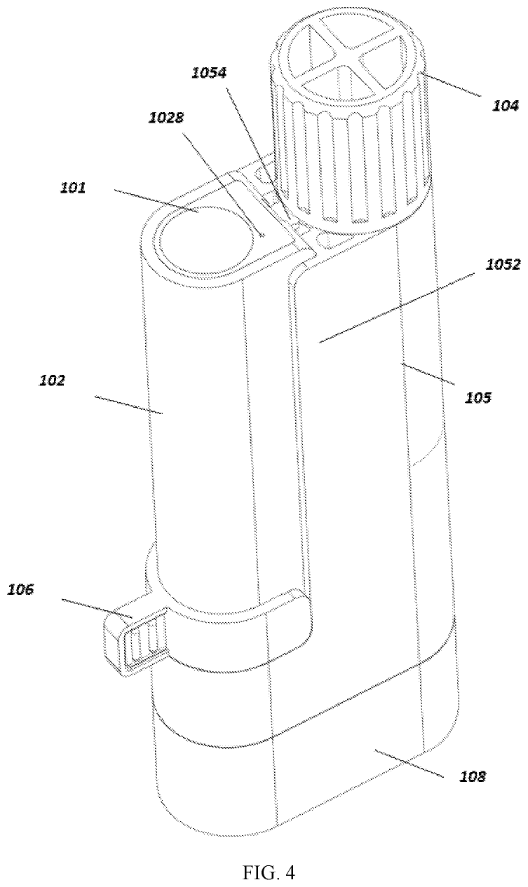

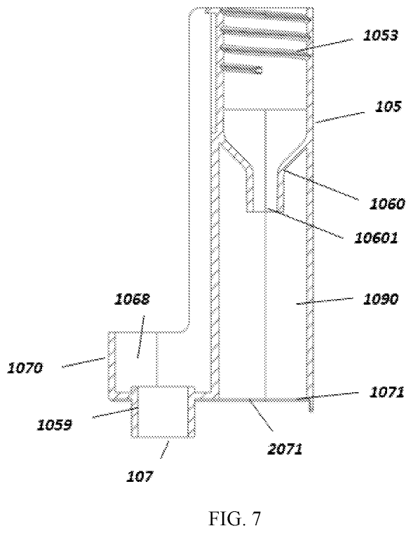

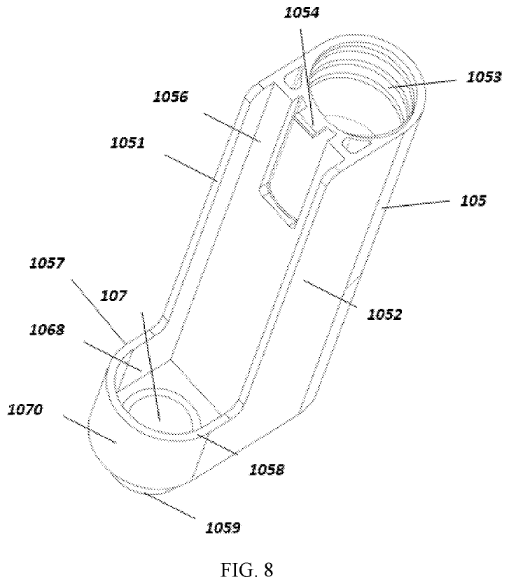

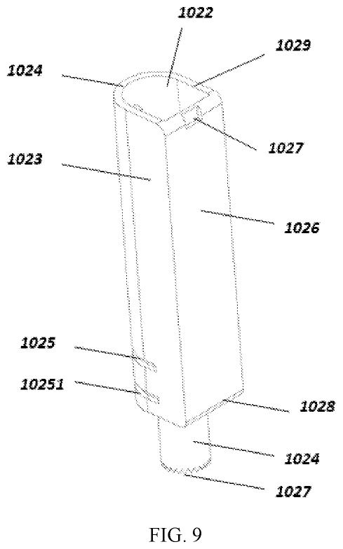

As shown in FIG. 3, FIG. 5, FIG. 7 and FIG. 8, in some embodiments, the invention provides a sample chamber 105; the sample chamber includes an opening 1053 and a bottom 1071; a sample retention structure 1060 is annularly provided at the center of the sample chamber and has a hole 10601 at the center thereof; the size of the hole matches the diameter of a sampling rod of a sample collector, such that the sampling rod 1046 can pass through the hole; if there are excess samples on the sampling rod, the excess samples can be left on the sample retention structure without flowing into the sample chamber at the lower part of the sample retention structure depending on the restriction of the hole. The sample collector 104 includes a cover 1041, the sampling rod 1046 connected with the cover, and a sampling area 1047 provided at the head of the sampling rod, where the sampling area can also be called a sampling head or a sampling part and is used for sampling. Thus, after the sample collector 104 is inserted into the sample chamber 105, the sampling area 1047 is located in the chamber 1091 below the sample retention structure 1060. If the treatment liquid is stored in the sample chamber in advance, the sampling area is immersed in the treatment liquid, and the samples on the sampling area 1047 are dispersed in the treatment liquid to form a mixed solution. Screw threads are provided outside the cover of the sample collector and inside the opening 1053 of the sample chamber 105; and the screw threads on the sample collector 104 isomorphically match with the screw threads near the opening of the sample chamber to rotationally seal the opening 1053 of the sample chamber. In some embodiments, the bottom of the sample chamber may be further provided with the sealing film 107, and the sealing film can be pierced; for example, after the sample collector is inserted into the sample chamber, the head of the sampling area 1047 is of a sharp structure, such that a sharp end of the sample chamber can be allowed to pierce the sealing film 2071, and the liquid in the sample chamber 105 can flow out of the sample chamber through the pierced sealing film at the bottom.

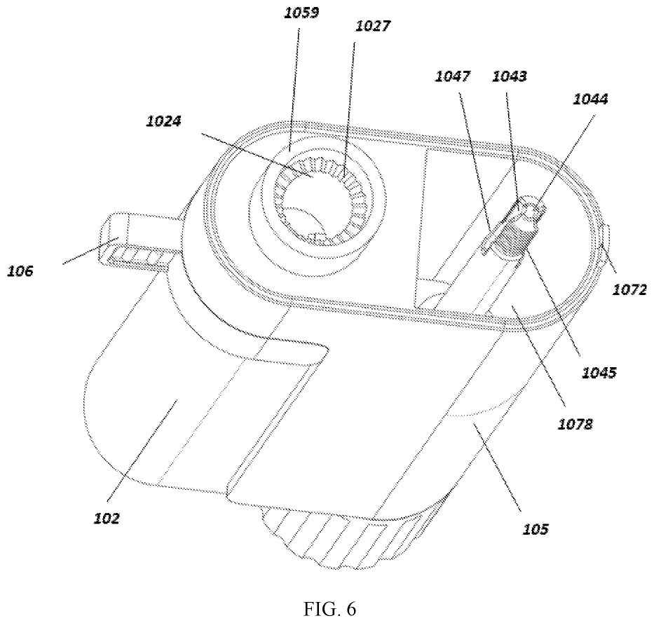

In some embodiments, a side of the sample chamber is provided with a receiving area 1068 in which the detection chamber 102 is inserted; the receiving area 1068 is a recessed interface and substantially located near the bottom 1071 of the sample chamber; the recessed area is enclosed by side walls 1070; the side walls have a specified thickness and annular edges 1057, 1058, and the edges with a thickness are to allow a positioning structure 106 to be retained on the side walls stably, so as to keep the detection chamber in the first position stably. For example, the positioning structure 106 is an annular positioning ring, and the annular snap ring 1061 also has a thickness. The inner surface of the snap ring of the positioning structure is provided with a protruding clamping rail 1063 snap-fitted on the grooves 1025, 10251 of the detection chamber 102, which limits the position of the detection chamber; and the edges of the snap ring of the positioning structure are located on the edges of the side walls of the recessed area, such that the detection chamber is located at the first fixed position (as shown in FIG. 6). The following makes detailed explanations. In one embodiment, one chute 1056 is provided beside the recessed area 1068 and on a side of the sample chamber, and the test chamber 102 is fixed inside the sample chamber through the chute; the chute consists of two sides 1051, 1052 configured in a face-to-face manner, the width of a sliding rail is equivalent to that of one face 1026 of the detection chamber, such that the face of the detection chamber 102 is in contact with the sliding rail 1056 and slides along the sliding rail, for example, slides up and down relative to the sample chamber.

When the detection chamber 102 is combined with the sample chamber 105, one end of the bottom 1028 of the detection chamber 105 is inserted into the recessed area 1068, one side wall 1026 of the detection chamber 102 is abutted on the sliding rail 1056, and the left and right positions are defined by the side walls 1051, 1052 on the sliding rail. In some embodiments, in order to make the detection chamber stably located in the recessed area 1068, a snap-fit mechanism 1054 is provided at the top of the chute, and the top of the detection chamber is provided with a notch 1027 near the top of the side wall 1026. When the detection chamber is located in the recessed area and the side walls are close to the chute 1056, the snap-fit mechanism 1054 is snap-fitted on the notch 1027 and has elasticity to give the notch 1027 a rebound force. Thus, the detection chamber can be stably combined with the sample chamber, and also stably located in the recessed area 1068 of the sample chamber. The block diagrams of the combination mode are as shown in FIG. 5 and FIG. 6, where FIG. 6 is a schematic diagram without a base, and FIG. 5 is a schematic view without a cover to seal the opening 1022 of the detection chamber 102.

After the detection chamber is combined with the sample chamber, as shown in FIG. 5-FIG. 6 and combined with a cross-section diagram 10A, the base chamber is absent in these examples. In this case, the bottom 1028 of the detection chamber is higher than the bottom 1071 of the sample chamber, but if the level of the liquid in the sample chamber 105 is higher than the bottom of the detection chamber 1028, for example, slightly lower than the sample retention structure in the sample chamber 105, or if the level of the liquid in the sample chamber 105 is bit higher than the bottom 1028 of the detection chamber and when the detection chamber is kept in communication with the sample chamber, the liquid in the sample chamber can flow into the detection chamber; the two chambers reach a balance when having the same level of the liquid; in this case, the liquid in the detection chamber 102 contacts with the testing element of the detection chamber to complete testing of the analyte. Of course, when the detection chamber is not in communication with the sample chamber, no liquid flow occurs. Therefore, the liquid does not flow between the sample chamber 105 and the detection chamber 102 before testing is performed. When the sample collector with the collected sample is inserted into the sample chamber, the collection area 1047 of the sample collector is located in the liquid within the sample chamber, and in this case the liquid is the solution for treating the sample and used for dissolving the analyte in the sample; and when testing needs to be performed, the detection chamber is in fluid communication with the sample chamber, the liquid in the sample chamber at the high level flows into the bottom 1028 of the detection chamber 102 at the low level to contact with the sample application area of the testing element. It can be understood that the volume of the liquid in the sample chamber 105 may be adjusted to control the level of the liquid in the sample chamber to prevent the liquid from flowing too much into the detection chamber. For example, after the shapes and dimensions of the sample chamber and detection chamber are determined, and when the specific relative positions of the sample chamber and detection chamber are fixed, a fixed liquid volume is set in the sample chamber to allow the detection chamber to accommodate a fixed volume of the liquid from the sample chamber; in case of the fixed liquid volume, the level of the liquid in the sample chamber is determined. Therefore, a preferred example is that the level of the liquid in the sample chamber needs to be higher than the height of the position indicated by the bottom 1028 of the detection chamber. This is due to a fact that the bottom 1028 of the detection chamber 102 is the area where the sample application area 905 of the testing element 900 is positioned.

In some embodiments, one channel (omitted) is provided between the detection chamber and the sample chamber, and the channel may have a closed state and an open state; when the channel is closed, the flow of the liquid between the detection chamber and the sample chamber is not possible; and when the channel is opened, the flow of the liquid between the detection chamber and the sample chamber is possible. Generally, when the channel is closed, the sample collector can be used for collecting the sample and be inserted into the sample chamber before testing is performed; if testing needs to be performed, the channel is allowed to be opened, and the liquid can flow into the detection chamber from the channel to assay the analyte. If the channel is opened and closed, the sealing plug or the sealing film can be provided in the channel to seal inlets or outlets at both ends of the channel. Generally, the channel has openings in two ends, where the opening in one of the two ends is connected with the sample chamber, such that the liquid in the sample chamber flows into the channel (inlet); and the opening in the other end thereof is connected with the detection chamber, such that the liquid in the channel flows into the detection chamber (outlet); therefore, if the inlet or the outlet is sealed by the sealing film or the inlet and the outlet are sealed by the sealing film, the channel can be closed and opened. For example, at the beginning, the sealing film is allowed to seal the inlet (in the closed state), and the inlet is generally located at the bottom 1071 of the sample chamber and below a sample retention hole (namely, below the tip of the sampling area 1047 of the sample collector (when the sample collector is inserted into the sample chamber); therefore, when the sample collector is inserted into the sample chamber, the tip can be in contact with and pierce the sealing film; after the sealing film is pierced, the liquid in the sample chamber at the high level flows into the detection chamber (the channel is opened) through the channel due to a pressure difference. When the sealing film is used for sealing the outlet of the channel, the inlet of the channel can be in direct communication with the sample chamber instead of being sealed. Similarly, when testing needs to be performed, the detection chamber is provided with the piercing element, and the detection chamber is allowed to move downward to pierce the sealing film of the outlet, such that the liquid can still flow into the detection chamber 102 and complete the test and assay. Of course, if both the outlet of the channel and the inlet of the channel are sealed, the flow of the liquid between the detection chamber and the sample chamber can still be realized by piercing the sealing film at the inlet through the tip of the sample collector and piercing the sealing film at the outlet through the piercing element on the detection chamber.

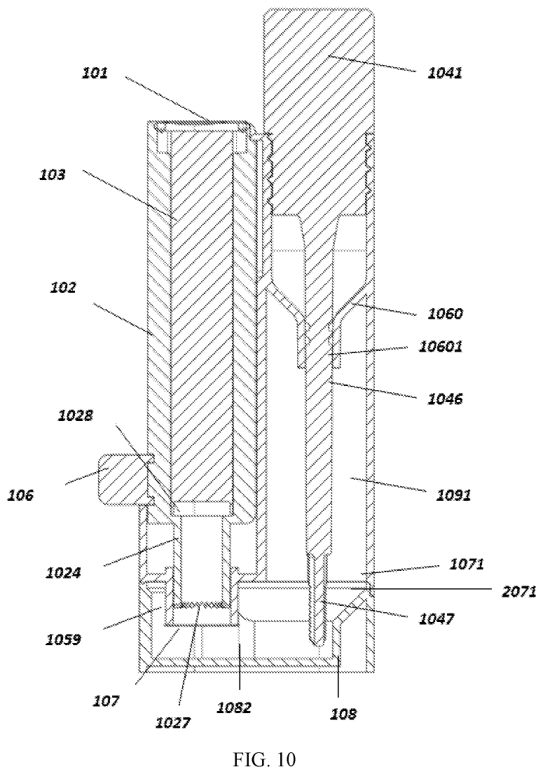

In one embodiment, the detection chamber is allowed to be connected with the sample chamber through the connecting chamber, such that a circulation state between the two chambers can be realized. For example, one base 108 is provided; the base includes a recessed area 1081 therein, the recessed area 1081 is combined with a bottom of the sample chamber 105 and has an annular edge 1084 and an annular edge 1078 at the bottom of the sample chamber; an insert 1072 is provided at the side of the bottom of the sample chamber, and the insert is inserted into a socket 1083 of the base 108; thus, such assembly is performed in this manner, one connecting chamber 1082 (as shown in FIG. 10) is formed, and the detection chamber 102 and the sample chamber 105 are connected through the connecting chamber 1082. In order to ensure the sealing property of the formed connecting chamber 1082, the connecting chamber can be ultrasonically welded.

In some embodiments, an easy-to-pierce sealing film can be provided between the sample chamber 105 and the connecting chamber. For example, a sealing film 2071 can be provided between the bottom 1071 of the sample chamber and the connecting chamber 1082 and used as the bottom 1071 of the sample chamber and can be pierced, meaning that the flow of the liquid between the connecting chamber 1082 and the sample chamber is blocked by the sealing film 2071. Optionally, the sealing film 107 can be provided between the connecting chamber 1082 and the detection chamber 102 and can also be pierced, meaning that the flow of the liquid between the detection chamber and the connecting chamber 1082 is blocked by the sealing film 107. These two sealing films 2071, 107 may be together provided, or in some cases, either one may be absent. Therefore, the flow of the liquid between the sample chamber 105 and the detection chamber 102 will be blocked; and when the liquid in the sample chamber needs to flow into the detection chamber, the two films will be pierced one after another or either one will be pierced to realize the flow of the liquid. For example, after the sample collector 104 is used for collecting the sample, the sample collector is inserted into the sample chamber 105, and the collection area 1047 of the sample collector has a tip; after the sealing film 2071 is pierced by the tip, the liquid will flow from the sample chamber 105 to the connecting chamber 1082 and the connecting chamber is filled with the liquid, because the level of the liquid in the sample chamber is higher than the bottom 1028 of the detection chamber; after the connecting chamber 1082 is filled with the liquid, the level of the liquid in the sample chamber 105 is still higher than the bottom 1028 of the detection chamber, and therefore there is a pressure difference between the sample chamber and the detection chamber. When testing needs to be performed, the detection chamber 102 is allowed to move downwards, and the piercing element on the detection chamber 102 pierces the sealing film 107, such that the liquid flows into the detection chamber for assaying or testing in a case that the two sealing films 107, 2071 coexist. When both ends are sealed, there is the liquid only in the sample chamber, instead of the connecting chamber 1082 and the detection chamber. Only when testing is performed, the sealing film between the sample chamber and the connecting chamber 1082 is pierced, such that the liquid in the sample chamber 105 flows into the connecting chamber 1082 and the sealing film 107 between the detection chamber, and the connecting chamber 1082 is pierced by the piercing element on the detection chamber. It can be understood that a sequence of piercing the sealing film 2071 between the sample chamber 105 and the connecting chamber 1082 and piercing the sealing film 107 between the detection chamber 102 and the connecting chamber 1082 is not necessarily determined.

In some embodiments, only the sealing film 107 is used for sealing the detection chamber and the connecting chamber and isolating the detection chamber 102 from the connecting chamber 1082, no sealing film 2071 is provided between the sample chamber and the connecting chamber, and the sample chamber is absent from the bottom 1071; actually, the connecting chamber 1082 is combined with the inside of the sample chamber 105 to form one chamber; when the liquid is injected into the sample chamber, the connecting chamber 1082 is filled with the liquid, and the liquid is accommodated in a part of the chamber 1091 in the sample chamber 105; in this case, the level of the liquid is still higher than the bottom 1028 of the detection chamber, such as 5 millimeters high, 1 centimeter high, and 2-10 centimeters high. When testing is performed, the sample collector is still used for collecting the sample and is inserted into the sample chamber 105; and the sample collected in the collection area of the sample collector is tested. When testing needs to be performed, the detection chamber is allowed to move downwards from the first position to the second position; and the piercing element on the detection chamber 102 pierces the sealing film 107, such that the detection chamber is in fluid communication with the connecting chamber 1082 and the sample chamber. Because the level of the liquid in the sample chamber is higher than the bottom 1028 of the detection chamber, there is a liquid pressure difference between the sample chamber and the detection chamber, and the liquid will flow into the detection chamber and contact with the testing element at the bottom of the detection chamber.

In some embodiments, a connecting channel 1059 is provided below the recessed area of the sample chamber and has an outlet and an inlet; the outlet is sealed by the sealing film 107, the detection chamber 102 also has an insertion end extending from the bottom 1028, and the insertion end is also in the form of a channel 1024 or a pipe; the channel has the outlet, a sharp piercing element 1027 is provided on the edge of the outlet, the insertion end is located in the connecting channel 1059 (as shown in FIG. 10A) and has the limiting function of the limiting structure 106 at the initial position, and the insertion end of the test chamber is located in the communication channel, but the piercing element is not allowed to contact the sealing film 107. In this case, the fluid communication between the connecting chamber 1082 and the detection chamber 102 is blocked due to the sealing of the sealing film 107. In this case, the connecting chamber 1082 may also be filled with the liquid, and the liquid is also accommodated in the sample chamber, especially in the sample chamber 1091 under the hole 10601 of the sample retention structure 1060, and the level of the liquid is higher than the bottom 1028 of the detection chamber. In some embodiments, the outlet of the connecting channel 1059 is not sealed by the sealing film 107, but a sealing plug (omitted), such as a silicone plug, is provided in the connecting channel 1059 to block the flow of the liquid between the detection chamber 102 and the connecting chamber 1082. When testing needs to be performed, the detection chamber 102 is allowed to move downward from a fixed position, and the channel 1024 is allowed to move downward to eject the sealing plug from the channel 1059 to connect the two chambers.

In some embodiments, when the sample collector 104 is inserted into the sample chamber, the collection area 1047 is located in the connecting chamber 1082. This has a great advantage, especially when the sample collector is used for collecting solid or semi-solid samples. As shown in FIG. 6, the collection area 1047 of the sample collector 104 has a groove 1043, or two symmetrical grooves 1043, 1044, and there is a threaded structure 1045 in the area between the two grooves. With this design, liquid samples or semi-solid samples can be used by virtue of the surface tension of the threaded structure, but the groove is used for collecting the solid samples through the hole 10601 in the sample retention structure 1060; when there are many samples in the groove, the solid samples are fixed in the groove through the hole 10601, and the excess samples are retained on the sample retention structure 1060, so as to realize the quantitative sampling of the samples. If the samples are solid samples, such as fecal samples, and when the samples are inserted into the sample chamber, the collection area is directly inserted into the connecting chamber 1082, the liquid in the connecting chamber 1082 dissolves the solid samples, a volume of a relatively high-concentration liquid containing the sample forms in the connecting chamber 1082 or the solution in the connecting chamber 1082 around the sampling area 1047 contains a high-concentration sample; as time extends, the sample will diffuse from the periphery of the collection area 1047 to all sides. In this case, it is desired that testing will be performed as soon as possible, the detection chamber 102 is allowed to move downward and pierce the sealing film 107, thereby forming fluid communication between the detection chamber and the connecting chamber 1082. The liquid in the sample chamber is higher than the bottom 1028 of the detection chamber, so there is a height difference between the sample chamber and the detection chamber, and the liquid will flow to the detection chamber. In a liquid flow process, the liquid in the connecting chamber 1082 flows forward into the detection chamber, and then the liquid in the sample chamber flows into the connecting chamber 1082; in addition, the flow of the liquid in a similar flow pipe is based on an existing sequence. Therefore, if the collection area 1047 is allowed to be located in the connecting chamber 1082, the requirements of rapid testing can be met. After all, the solution in the connecting chamber dissolves the sample to form a mixed solution, and the mixed solution can reach the testing area in advance. On the contrary, if the collection area 1047 of the sample collector is located in the sample chamber, such as the chamber 1091 below the sample retention structure, the liquid in the chamber 1091 contacts with the collection area 1047 and forms a high-concentration sample solution; however, there may be no sample in the connecting chamber 1082 or the concentration of the sample in the connecting chamber 1082 is low. Testing is initiated immediately once the sample collector is inserted into the sample chamber 105, the liquid in the connecting chamber 1082 flows into the detection chamber 102, but the concentration of the sample in the connecting chamber is relatively low; if the sample contains the analyte, the content of the analyte is very low, resulting in a false negative result. In order to obtain the accurate testing results, testing can be initiated only when the samples collected in the collection area 1047 are completely dissolved in the liquid and form a uniform concentration. However, if the solid samples are collected in the collection area, it will take a long time for the solid samples to be dissolved in the liquid and form a mixture with the uniform concentration, that is, it will take about 1-5 minutes or even 5-10 minutes for both the sample chamber and the connecting chamber to contain samples and form a uniform sample concentration, which will inevitably affect rapid testing. The “sample concentration” herein means the concentration of the collected sample dissolved in the liquid, and the liquid herein may be a dissolved solid sample or a liquid sample. It can be understood that the sample concentration is uniform and the analyte is substantially in a uniform state. Such a device is especially used for home self-testing when an operator always wants to get the testing results as soon as possible, rather than waiting for a long time, and wants the sample collector where the sample has been collected to be inserted directly into the sample chamber and then initiates testing. Therefore, the collection area 1047 of the sample collector can be directly inserted into the connecting chamber 1082 through the sample chamber 105, and the rapid testing can be realized. Therefore, as shown in FIG. 6 and FIG. 10, the sample collector appears to be particularly long, and especially the collection rod is also relatively long, such that the collection area 1047 can reach directly beyond the bottom of the sample chamber 1071 and enter into the connecting chamber 1082.

When the level of the liquid in the sample chamber is higher than the bottom 1028 of the detection chamber, the liquid can smoothly flow into the detection chamber, and some vent holes can be provided in the detection chamber, so when the liquid flows into the detection chamber, the excess gas is discharged, and a pressure applied to the detection chamber is reduced when the gas is compressed. In some embodiments, some vent holes are provided in the sample chamber or the sample collector and are liquid-impermeable holes. The arrangement of these holes is to keep the sample chamber and the detection chamber in communication with the outside under an equal air pressure, such that the liquid at the high level of the sample chamber can flow from the high level of the liquid in the sample chamber to the detection chamber at the low level more easily. Herein, the level of the liquid is generally relative. The bottom 1028 of the detection chamber is generally in a horizontal position, and the sample application area of the testing element is located near or in direct contact with the bottom. Once the liquid flows into the bottom of the detection chamber from the channel 1024, a high level of liquid is formed at the bottom, and the level of the liquid in the sample chamber is higher than the bottom of the detection chamber. This height difference may be 1-2 cm, 10 mm or 10 cm. In some embodiments, the cover 1041 of the sample collector and the opening 1053 of the sample chamber are designed with a relatively long screw thread in order to allow the liquid to flow into the detection chamber quickly. Therefore, when the cover enters the sample chamber through rotation, the gas in the sample chamber is compressed and an increased air pressure is formed, and the screw thread is substantially hermetically sealed; as the length of the screw thread is relatively long, the air pressure in the sample chamber can be increased. Once sealing between the detection chamber and the connecting chamber is removed, the air pressure in the sample chamber can force the liquid to flow the detection chamber more quickly, meaning that there is a pressure difference in the level of the liquid; with an increase in gas pressure, the liquid can flow into the detection chamber quickly.

In some embodiments, the detection chamber has a first position and a second position; the detection chamber cannot move when being located at the first position; in order to make the detection chamber unable to move, a limiting structure is provided on the detection chamber, for example, a limiting card 106; the limiting card has a snap ring 1061 with a thickness, where the snap ring is in the form of a semicircle, an inner surface of the snap ring is provided with an annular track 1063, and the groove 1025 is provided in an outer wall of the detection chamber; when the detection chamber 102 is located at the first position, the track 1063 in the snap ring 1061 is clamped in the groove in the detection chamber 102, and the edges of the snap ring are retained on the concave edges 1058, 1057, thereby limiting the movement of the detection chamber 102. The movement herein mainly means the upward or downward movement of the detection chamber in the longitudinal direction of the sample chamber, so the first position is a fixed position, the piercing structure on the detection chamber cannot pierce the sealing film, or when the sealing plug is provided in the channel 1059, the pipe of the detection chamber is in contact with the sealing plug. When the snap ring 106 is removed, a pressure is applied to the detection chamber by an external force to move the detection chamber 102 from the first position to the second position, and the piercing element on the detection chamber pierces the sealing film 107 or the sealing plug is allowed to fall off from the pipe 1059 to form communication between the connecting chamber 1082 and the detection chamber, such that the liquid can flow from the connecting chamber 1082 to the bottom 1028 of the detection chamber.

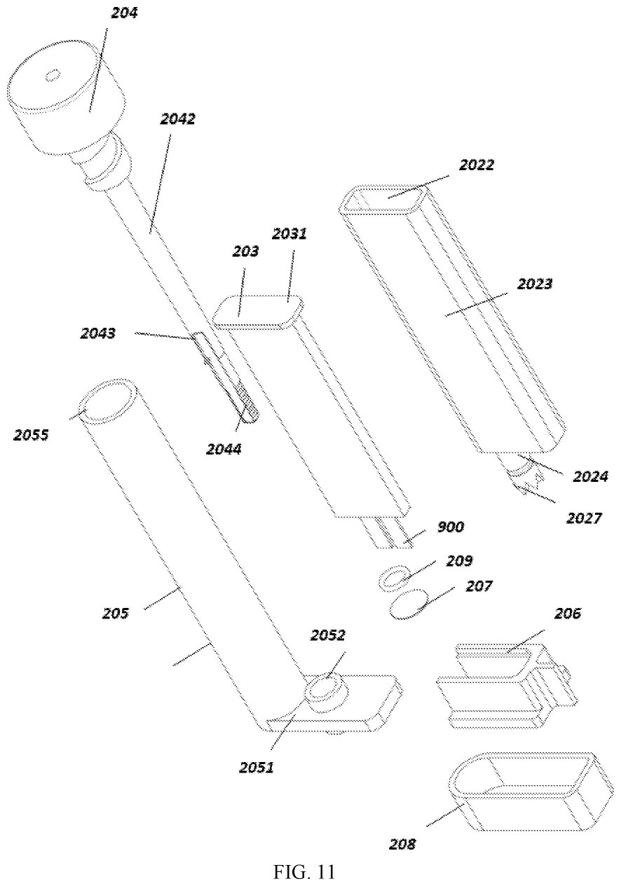

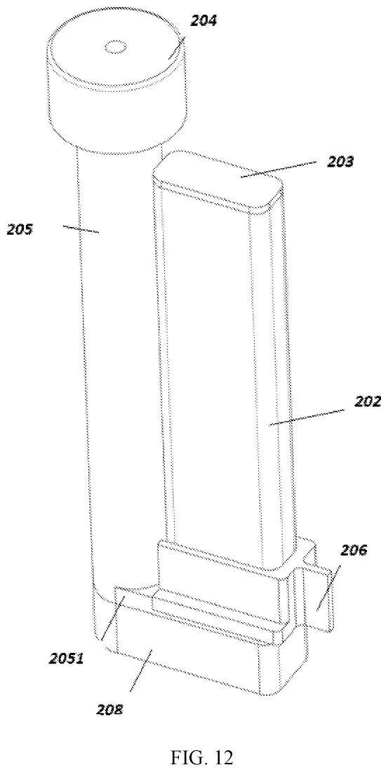

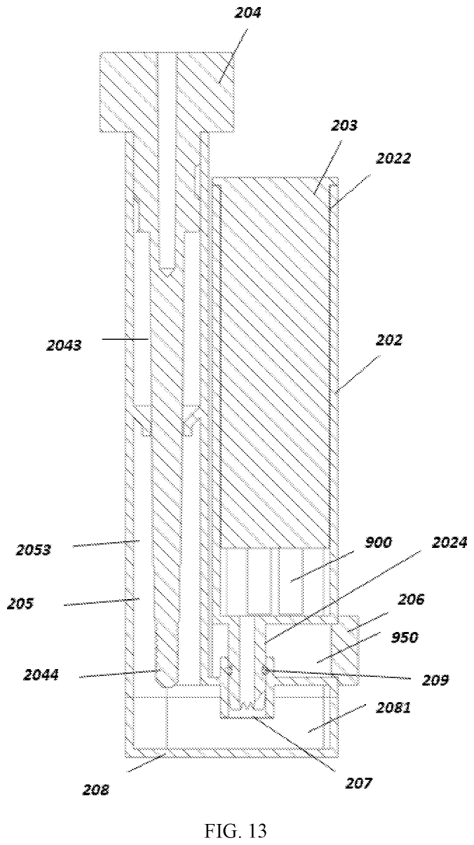

In some embodiments, the testing device of the invention is the same as another testing device, its basic design is also that fluid communication is realized through the movement of the detection chamber so as to realize testing. For example, as shown in FIG. 11-FIG. 13, the device also includes a sample chamber 205 including a chamber 2053 and a sealing cover 2059 connected with the chamber, where the sealing cover includes one channel 2052 running through the cover 2059 and extending out of the upper and lower surfaces of the cover. The cover seals the base 208, such that a connecting chamber 2081 is formed in the base 208 and in fluid communication with the sample chamber. If the liquid is accommodated in the sample chamber 205, the liquid is also accommodated in the connecting chamber 2081, and the liquid is generally located in the chamber 2054 below the sample retention structure of the sample chamber. The sample collector 204 includes the cover to seal the sample chamber and a rod-shaped structure 2043 connected with the cover. The tubular structure is provided with the collection area 2043, and the collection area is used for sticking the sample, especially a semi-solid sample, such as a fecal sample. The fecal sample is generally a sticky semi-solid sample, and can be collected by the collection area 2043. Similarly, the sample retention structure is provided in the sample chamber to remove the excess sample in the collection area 2043. The device of the invention further includes a detection chamber 202, where the detection chamber includes an opening 2022 and a transparent side wall 2023 and is in a shape of a cuboid; a carrier 203 is inserted into the detection chamber and provided with a testing element 900 thereon, where the testing element is fixed onto the carrier 203 and the sample application area protrudes from the bottom of the carrier 203; and when the carrier is inserted into the detection chamber, the sample application area of the testing element 900 is located at the bottom 2028 of the detection chamber. In one embodiment, the detection chamber is further provided with a pipe 2024, one end of the pipe is in communication with the inside of the detection chamber, and the other end thereof is inserted into the channel 2052; and one end of the channel is in communication with the pipe 2024, and the other end thereof is located in the connecting chamber 2081. The outer wall of the pipe 2024 is provided with a sealing ring 209, and its function is to form a seal between the pipe 2024 and the channel 2052, especially a hermetic seal structure. A piercing structure 2027 is provided at the inlet of the pipe, and the sealing film 207 is provided at the channel 2052, so as to block the fluid communication between the connecting chamber 2081 and the detection chamber 202. A limiting structure 206 is provided and clamped on the detection chamber; specifically, the pipe 2024 has a length; when the pipe is inserted into the pipe 2025, the bottom 2028 of the detection chamber still has a distance from the pipe 2024 and is similar to a neck structure; and the limiting structure 206 is directly clamped on the neck structure (as shown in FIG. 13), thereby limiting the first position of the detection chamber. The detection chamber has the opening 2022, and the carrier has the cover 2031. The cover 2031 of the carrier seals the opening 2022 of the detection chamber to form a sealed chamber, and a vent hole (omitted) is also provided in the detection chamber 202. When the limiting structure 206 is removed, the detection chamber 202 can be allowed to move downward. In the embodiment, a difference is that when the piercing structure 2027 on the detection chamber pierces the sealing film 207, a part of the pipe 2027 still moves downward because the pipe 2027 and the pipe 2052 are still kept hermetically sealed by the sealing ring 209. The pipe 2024 moving in the pipe 2052 will inevitably generate pressure to the connecting chamber. On the one hand, the pressure is applied to the liquid; on the other hand, the movement will also result in an increase in the air pressure of the connecting chamber, and the increased air pressure will force the liquid to flow into the pipe 2024 and the detection chamber to complete testing.

All the patents and publications mentioned in the description of the invention indicate that these are public technologies in the art and can be used by the invention. All the patents and publications cited herein are listed in the references, just as each publication is specifically referenced separately. The invention described herein can be realized in the absence of any one element or multiple elements, one restriction or multiple restrictions, where such restriction is not specifically described here. For example, the terms “comprising”, “essentially consisting of” and “consisting of” in each embodiment herein may be replaced by the rest 2 terms. The term “a/an” herein merely means “one”, but does not exclude including 2 or more instead of including only one. The terms and expressions which have been employed herein are descriptive rather than restrictive, and there is no intention to suggest that these terms and expressions in this description exclude any equivalents, but it is to be understood that any appropriate changes or modifications can be made within the scope of the invention and appended claims. It can be understood that the embodiments described in the invention are some preferred embodiments and features. Any person of ordinary skill in the art can make some modifications and changes according to the spirit of the description of the invention. These modifications and changes are also considered to fall within the scope of the invention and the scope limited by independent claims and dependent claims.

1. A device for testing an analyte in a liquid sample, comprising:
a sample chamber for accommodating a sample collector;
a detection chamber with a bottom, wherein a testing element is provided in the detection chamber and used for testing an analyte in a liquid chamber; and
a connecting chamber, wherein the sample chamber is connected with the detection chamber through the connecting chamber, a liquid is accommodated in the sample chamber, and a level of the liquid in the sample chamber is higher than a bottom of the detection chamber.

2. The device according to claim 1, wherein when the detection chamber is located at a first position, the detection chamber is not in fluid communication with the sample chamber; and when testing needs to be initiated, the detection chamber is allowed to be located at a second position and the detection chamber is kept in fluid communication with the sample chamber through the connecting chamber.

3. The device according to claim 2, wherein a pierceable sealing film is provided between the connecting chamber and the detection chamber, such that no fluid communication is made between the detection chamber and the connecting chamber.

4. The device according to claim 3, wherein the pierceable sealing film is provided between the connecting chamber and the detection chamber, such that no fluid communication is made between the sample chamber and the connecting chamber.

5. The device according to claim 3, wherein fluid communication is made between the connecting chamber and the sample chamber, and the liquid is also accommodated in the connecting chamber.

6. The device according to claim 5, wherein the detection chamber has the first position and the second position; when the detection chamber is located at the first position, the detection chamber is not in fluid communication with a chamber of a base based on sealing of the sealing film; and when the detection chamber is located at the second position, the detection chamber is in fluid communication with the connecting chamber based on piercing of the sealing film.

7. The device according to claim 6, wherein the device further comprises a piercing element, and the piercing element is capable to make a same position change together with the detection chamber.

8. The device according to claim 7, wherein when the detection chamber is located at the first position, a piercing structure does not pierce the sealing film; and when the detection chamber is located at the second position, the piercing structure pierces the sealing film.

9. The device according to claim 6, wherein the piercing element is located on the detection chamber and connected with the detection chamber to form an integral structure; the detection chamber further comprises a tubular structure, one end of the tubular structure is in fluid communication with the detection chamber; and the other end of the tubular structure is provided with the piercing element.

10. The device according to claim 9, wherein a channel is provided between the connecting chamber and the detection chamber; the sealing film is used for sealing the channel; the tubular structure is located in the channel; and the piercing element is located on the sealing film.

11. The device according to claim 10, wherein when the detection chamber is located at the first position, the tubular structure is located at the first position and the piercing element on the tubular structure does not pierce the sealing film; and when the detection chamber is located at the second position, the piercing element on the tubular structure pierces the sealing film, such that the connecting chamber is in fluid communication with the detection chamber through the channel.

12. The device according to claim 11, wherein the liquid comprising a solution for treating a sample is accommodated in the sample chamber, and the solution is also accommodated in the connecting chamber.

13. The device according to claim 12, wherein the sample collector is provided in the sample chamber, and the sample collector comprises a cover for sealing an opening of the sample chamber and a collection area for collecting the sample.

14. The device according to claim 13, wherein the collection area comprises a groove for accommodating the sample and a threaded structure.

15. The device according to claim 14, wherein when the collection area is used for collecting the sample and a sample area is inserted into the sample chamber, the collection area is located in the connecting chamber.

16. The device according to claim 15, wherein the connecting chamber is located on the base, the sample chamber has a recess, and a part of the detection chamber is located in the recess.

17. The device according to claim 16, wherein the device further comprises a limiting structure, such that the detection chamber is located at a fixed position; and the limiting structure comprises a snap ring, and the snap ring is clamped in a groove of the detection chamber, such that the detection chamber is located at the first position.

18. The device according to claim 17, wherein when the limiting structure is removed, the detection chamber is capable to move from the first position to the second position.

19. The device according to claim 18, wherein when the limiting structure is removed, the detection chamber is capable to move up and down from the first position to the second position along a longitudinal direction of the sample chamber.

20. The device according to claim 19, wherein the sample is a fecal sample or a saliva sample, and the analyte is hemoglobin or Helicobacter pylori.
